(19) United States
(12) Patent Application Publication
(10) Pub. No.: US 2002/0178072 A1
(43) Pub. Date: Nov. 28, 2002

(54) Online shopping mall virtual association

(75) Inventors: Carl Phillip Gusler, Austin, TX (US); Rick Allen Hamilton, II, Charlottesville, VA (US)

Correspondence Address: Robert H. Frantz, P.O. Box 23324, Oklahoma City, OK, 73123-2334, US

(73) Assignee: International Business Machines Corporation, Armonk, NY

(21) Appl. No.: 09/864,113

(22) Filed: May 24, 2001

(51) Int. Cl. G06F 17/60

(52) U.S. Cl. 705/26

(57) ABSTRACT

A system and method for providing a social experience coupled to a virtual shopping mall which creates an apparent geographical coupling between cyberstores within the virtual mall and shoppers within the mall. An online mall shopper may configure a list of other shopping “buddies”. The online shopping mall system then notifies or otherwise alerts the shopper of the presence of other concurrently online shoppers from the buddy list, allows for the shoppers to communicate and move to each other's present position within the shopping mall. When both shoppers are at the same virtual position within the shopping mall, they are presented with the same product information or virtual mall images and sounds, such that they may communicate with each other about a product or store in the mall. Shoppers may find other “buddy” shoppers by proximity, common interest terms, and may introduce shoppers to each other to build group conversations.

### CROSS-REFERENCE TO RELATED APPLICATIONS CLAIMING BENEFIT UNDER 35 U.S.C. 120

This application is related to U.S. application Ser. No. ______ (to be amended when serial number has been assigned), docket number AUS920010173US1, filed on ______, 2001, by Rick Hamilton, II, et al., and is also related to U.S. application Ser. No. ______ (to be amended when serial number has been assigned), docket number AUS920010250US1, filed on ______, 2001, by Carl P. Gusler, both of which are commonly assigned with this application.

### FEDERALLY SPONSORED RESEARCH AND DEVELOPMENT STATEMENT

This invention was not developed in conjunction with any Federally sponsored contract.

### MICROFICHE APPENDIX

Not applicable.

### INCORPORATION BY REFERENCE

This related application U.S. application Ser. No. ______ (to be amended when serial number has been assigned), docket number AUS920010173US1, filed on ______, 2001, by Rick Hamilton, II, et al., and related U.S. application Ser. No. ______ (to be amended when serial number has been assigned), docket number AUS920010250US1, filed on ______, 2001, by Carl P. Gusler, are hereby incorporated by reference in their entireties, including drawings.

### BACKGROUND OF THE INVENTION

1. Field of the Invention

This invention relates to the technologies of online and e-commerce, and especially to the graphical technologies for representing commerce facilities, organization, and navigation of shopping centers. This invention more specifically relates to technologies for automatically alerting online shoppers to other concurrently online shoppers, finding other concurrently online shoppers, and communications there between.

2. Description of the Related Art

In today's competitive commercial and retail environment, owners and employees of physical “bricks and mortar” stores often view web-based commerce as competition. For example, a local bookstore owner recognizes such online proprietors as Amazon.com as a direct competitor. In some instances, retail franchise owners may view the online web site of the same franchise name, albeit operated by the master franchiser, as even more direct competition because there is a high level of overlap in inventory as well as identical name brand recognition.

Many online shopping “malls”, or “cybermalls”, have been developed as web-based purchasing has become culturally acceptable to consumers and as online purchasing security concerns have been addressed. However, these online shopping malls are typically little more than a group of hyperlinked web sites or portions of web sites, accessible through a common “home” page. Turning to FIG. 1, the well-known arrangement of web browser computers (1) and web servers (5) interconnected by the Internet or World Wide Web (3) or intranets (6). Typically, the browser computer (1) comprises a personal computer running a web browser software such as Netscape's Navigator, using a protocol such as Transmission Control Protocol/Internet Protocol (TCP/IP) running over a dial-up modem connect, digital subscriber line (DSL), cable modem, or the like. The web server (5) typically consists of a web platform, such as IBM's Websphere product, and communicates to browser computers using Hyper Text Transfer Protocol (HTTP) by transmitting web objects including Hyper Text Markup Language Documents (HTML), graphic images (GIF, JPEG, etc.), audio and video clips (AVI, WAV, etc.), JAVA applets, and other common types of content objects. Hyperlinking for automatically addressing these types of web objects is well known in the art, and is prevalent throughout today's web environment.

Cybermalls exist currently as a loose collection of store web sites, for example, a grouping of online shoe stores accessible by a single hop or “click” from a common access point. Some cybermalls are collections of store sites offering products with geographical relationships, such as products made only in New England, Idaho, or Hawaii. Many bricks-and-mortar malls provide a variety of store types, including some specialty stores, some department stores, and meeting places such as food courts and restaurants, as do many cybermalls.

During the 1980's when automatic teller machines (ATM) became widely available for bank customers, banks found that their ability to distinguish themselves from competitors was subsequently reduced as their clients visited their physical facilities less and less often, favoring to make most transactions with a convenient ATM. For example, a first bank may have established a very respectable, reliable image, with bank lobbies furnished in luxurious furniture, marble, and artwork. Clients who frequent this bank's lobby are given an impression that the bank is well established, and higher fees may be more acceptable. Another bank, perhaps a credit union, may adopt a more Spartan image, with more practical and cost effective furniture, such as “cube” furniture, in order to project an image of efficiency and cost effectiveness.

However, as bank clients began to conduct the vast majority of their banking transactions with an ATM, they visited the bank's actual facilities very seldom and in some cases never. So, the client's view of the bank became that of the ATM terminal not the bank's lobby or building. Since there is very little difference between the appearances of ATM terminals, banks subsequently found it very difficult to distinguish their desired image from their competitors images.

So has become the problem for retailers in malls and online. While in physical form in a mall, a retailer may use choices of lighting, display materials and designs, background sounds and music, and store facade design to generate an image, it is very difficult to present the same image in a distinguishing manner through a web browser. As such, some online-only retailers, such as Amazon.com, have been able to quickly establish an image comparable and competitive with bricks-and-mortar retailers such as Borders, and Barnes and Noble.

Presently, online marketplaces are frequently set up in one of two fundamental ways. Firstly, consider that stores and malls may be presented in their entirety as a single domain, with possible divisions between departments (e.g., men's wear, households, etc), as shown in FIG. 2. A mall home page (21) may contain a group of hyperlinks to various store home pages (23, 24, and 25), which in turn provide hyperlinks to department pages (26, 27, 28, 29, 200, and 201). The tree structure of these sites are well known and are not unlike the tree structures of other, non-retail web sites.

Secondly, online malls are often organized so that visiting one “mall-front” shows lists of stores of possible interest to the visitor, and often provide search facilities (36) based on store names or product categories, as shown in FIG. 3. In this example, the web browser framer (31) which is displayed on a portion (30) of a web browsing device's display provides BACK and FORWARD navigation buttons (33, 34), and a location or address entry (32). Some online malls, as well as some online convention halls (wherein virtual convention “booths” are presented), provide a map-like view (37) of the virtual “layout” of the mall. This usually does not correspond to a real mall design, but is presented to enhance the browser's shopping experience. The cursor or pointer (35) may be used by the browser to select an icon, button, or store on the map. Again, similar to the first method described, these stores may either be organized as separate domains or accessible through the same domain. Again, too, it is evident that this organization of information is not unlike organization of information on other types of non-retail web sites. Thus, the “look and feel” of visiting these types of online malls is not much different that that of visiting other types of web sites, and certainly does not parallel the full sensory experience of visiting a real, bricks-and-mortar mall. Current online malls have little commonality or coherence to result in return visits, known as “stickiness”, when compared to real shopping malls.

Many of the carefully selected factors in real stores are lost in the online shopping experience. A mall operator may group certain types of stores based on a crossover business potential. For example, a “bricks-and-mortar” mall operator may locate a linen store, a bath products store, and a women's dress shop in close proximity to each other to target female shoppers. This physical co-location is not reproduced in the cybermalls of today's technology.

Still other factors have not been translated well to the online experience in cybermalls and cyberstores, such as the use of background music and sounds to set a mood or environment to complement a store's or department's product lines.

One of the related applications disclosed a new method and system through which a shopper of an online shopping mall may be presented with an multimedia experience similar to a real shopping experience, including the ability to graphically navigate a map of a shopping mall, view images of mall structures such as store facades and hallways, enter stores and navigate hallways through selection of hot spots in images, and navigate within stores while being presented with images of the store interior spaces and products. During all of these processes, relevant sounds, such as background noise in the open spaces and background music within a store, are presented to the shopper, as well, in order to complete the pseudo-real shopping experience.

Although the online mall technology of the related patent application remedied some of the current problems in the art by allowing a more realistic multimedia “visit” to the online mall, and it remedied the problems of the are related to the ability of retailers to provide a carefully crafted shopping environment, it still lacks the social aspect of visiting a real mall. It is well known that many young people, especially teenagers, visit malls not only to shop for items but also to meet with their friends on a semi-random basis. These group of the purchasing public represents an increasingly strong customer base, as the buying power of shoppers in this age group has been increasing over the last few years. Older, adult shoppers also enjoy the social aspect of unexpectedly “bumping into” a friend or family member at a real shopping mall, although culturally they do not regularly go to a mall with a primary motive of meeting their friends.

This social aspect, however, has a significant impact on the purchasing traits of shoppers in malls. For example, if a shopper is browsing a shelf of products, and then unexpectedly encounters a friend, they may initially talk with one another casually. Then, the discussion usually turns to the product or products which the first shopper was previously considering. After some discussion, they may decide that the product is interesting and is worth a try, resulting in two sales instead of just one. The first shopper having the support of the opinion of the second shopper may be encouraged to purchase the product where that he or she may otherwise have been undecided and foregone the purchase.

This type of interaction also tends to draw shoppers from another part of the mall into a particular store. In another example, a first shopper visits a store, and sees an interesting product, but leaves the store undecided, possibly intending to return if he or she decides to purchase the store. While browsing in another store or walking in the mall corridors, the first shopper encounters a second shopper—a friend or relative. The first shopper then mentions the interesting new product to the second shopper, and they decide to return together to the original store to look at the product. This situation then, too, may result in a confirmed sale to the first shopper, and an additional sale to the second “friend” shopper.

The online shopping experience, however, lacks this social aspect, including the ability to meet a friend or “buddy”, either expectedly or unexpectedly, to communicate with that friend, and to share a common online shopping experience. While the related patent applications describe enhancements to the online shopping experience with respect to the environmental factors of the online stores and mall spaces, they do not encompass a solution to these social needs of shoppers.

Online shoppers currently have other means of communicating with friends, most notably electronic mail (e-mail) and America Online's Instant Messenger [TM]. Through use of e-mail, an online shopper of a typical online mall or store may send a web page or hyperlink to a page to a friend who may be interested in the same product or may be able to may a valuable comment regarding the product. An asynchronous e-mail conversation may be had between the two participants, the second shopper may “visit” the web page to see the product, and one or both of the shoppers may decide to purchase the item. While this is of some use, there is a temporal issue with the approach and technology. With normal e-mail, the first shopper is unaware of whether or not the buddy is currently online and accessing his or her e-mail. Thus, the first shopper may send the e-mail, and then move on to other shopping which raises the probability that the first shopper will not return to the original product and retailer to conclude a purchase (this is analogous to the “rule” of sales that says if a shopper leaves a real store, he is not likely to return for a purchase). Second, the ability to hold a “real time” discussion with the second shopper is limited due to the nature of standard e-mail.

Online chat rooms allow for a “real time” discussion between participants, and allow for establishing a private discussion. While a chat room partially solves the real time nature of the problem of a first shopper notifying a second shopper of a product of interest, chat rooms require special software on the servers which is not commonly part of an online e-commerce software suite. Additionally, there is no provision in a chat room to notify the first shopper that the second shopper is actually online.

America Online's Instant Messenger [TM] (AOL-IM) has an interesting combination of chat room-like functionality coupled with an automatic alerting function. A user of AOL-IM may configure a list of other users of AOL-IM which are friends, family or buddies. Then, as a first user logs into the Internet for browsing, he or she may also log into the AOL-IM server. If any user from his or her “buddy list” is already logged into the AOL-IM server, a notice or list is immediately given to the newly logged in member. Further, if the newly logged in user is on anyone else's buddy list, they are also sent a notification that the other user has just gone online. Subsequently, any user may easily initiate a chat room-like communications session with another friend on his or her buddy list who is also online. During registration with the AOL-IM server, a new user may also configure a profile including a user name and optionally his or her personal information (address, telephone number, etc.), and a list of interest terms (hiking, jazz music, etc.). Other users can search for users with specific interests to meet new potential friends.

However, AOL-IM does not relate to a specific online web site, but is a separate and independent service. So, if it were promoted by a particular online shopping mall as a method to meet other online friends, it would not only alert shoppers of other concurrently online shoppers of the same shopping mall, but would also alert user of all online “buddies”, including those who are currently browsing other online retailers. Thus, providing or encouraging use of AOL-IM may actually lead to online shoppers being drawn away from the online shopping mall, and attracted to other online resources by their online buddies.

Further, as the AOL-IM service is not geographically centered or oriented to any real or simulated space, it does not provide a visual method for “locating” a buddy on a user's buddy list.

Therefore, there is a need in the art for a method and system which allows an online shopper of an online shopping mall to automatically find other concurrently online shoppers of the same online shopping mall. There further exists a need for this ability to find other shoppers by name, personally identifying information, or interest lists. Additionally, there is a need in the art for this system and method to provide a visual presentation regarding the virtual location of one or more other shoppers within the online shopping mall (e.g. which store or mall space they are currently browsing). Further, there exists a need in the art for this system and method to provide chat room-like (near real time) communications between two or more shoppers, either in text form or multimedia (video and/or sound) form.

### BRIEF DESCRIPTION OF THE DRAWINGS

The following detailed description when taken in conjunction with the figures presented herein provide a complete disclosure of the invention.

FIG. 1 illustrates the well-known arrangement of web browser devices and web servers.

FIG. 2 shows the typical tree-like structure or organization of online mall information.

FIG. 3 shows a typical online mall front page with a “map” of a virtual mall.

FIG. 4 discloses the enhanced view of an online mall front page including a “you are here” indicator, buddy position indicators, and an icon to select the fall sensory presentation of the mall shopping visit.

FIG. 5 shows an example presentation of a visual image from a particular vantage point or position within a cybermall in which multiple adjacent store fronts may been seen.

FIG. 6 sets forth the common arrangement of components of web browsing devices such as personal computers, as well as mobile devices such as PDA's, web enabled telephones, and handheld personal computers.

FIGS. 7 and 8 illustrate the logical processes performed by the invention.

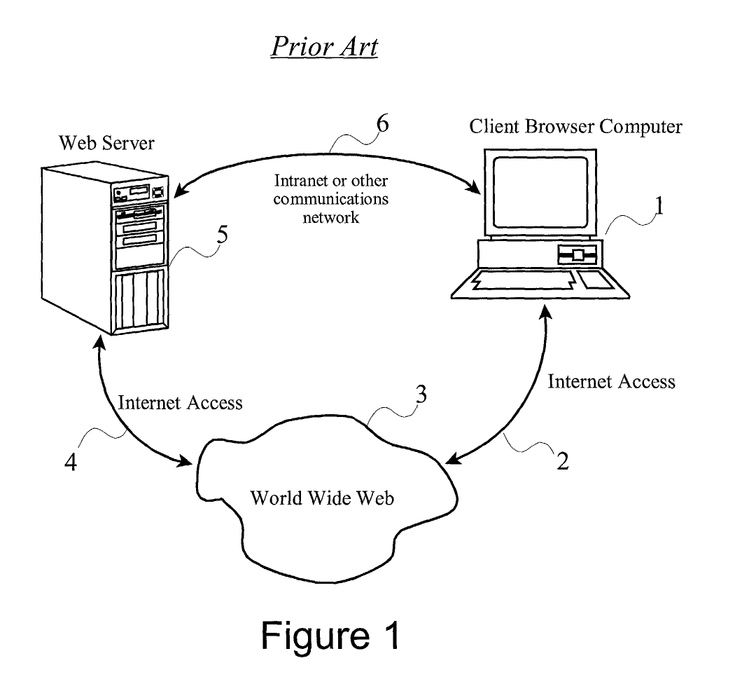

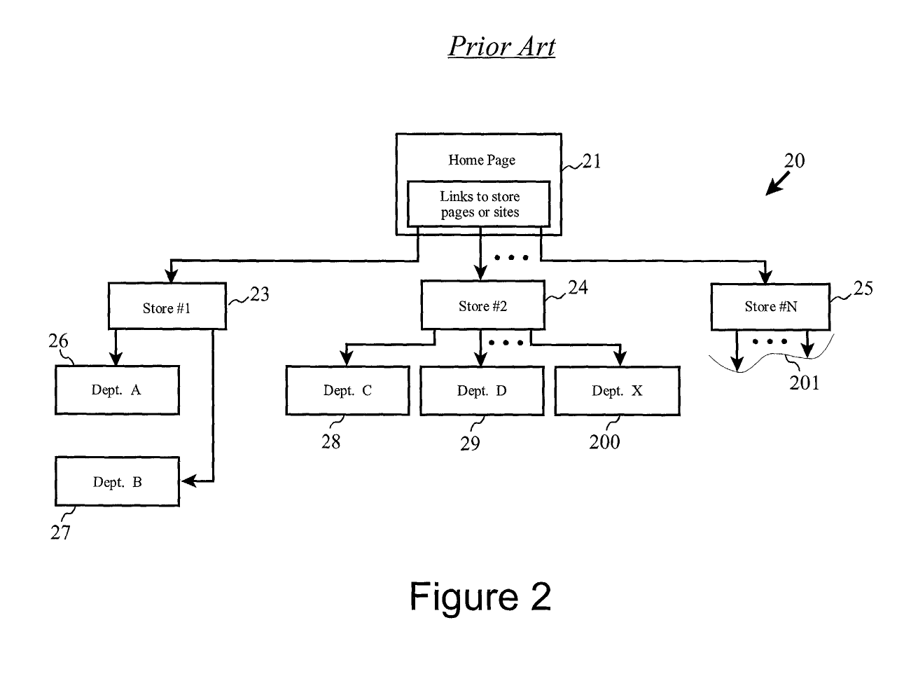

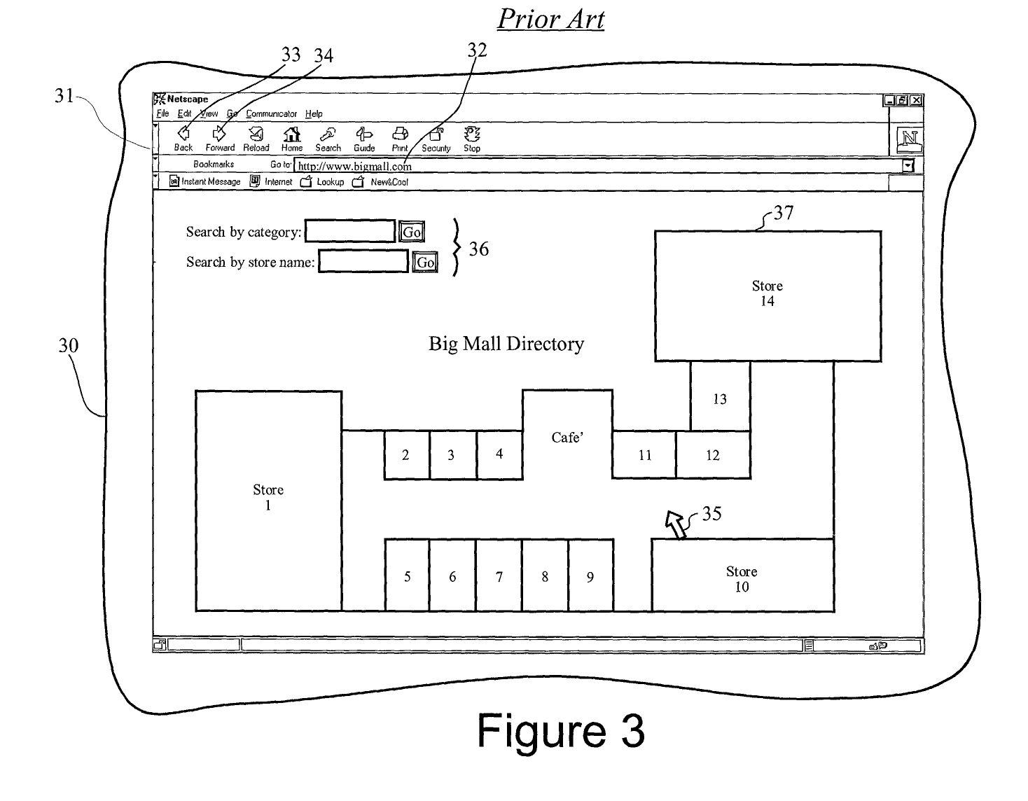

### SUMMARY OF THE INVENTION

The present invention provides an enhanced social experience coupled to an virtual shopping mall which creates an apparent geographical coupling between cyberstores within the virtual mall and shoppers within the mall. An online mall shopper may configure a list of other shopping “buddies”. The online shopping mall system then notifies or otherwise alerts the shopper of the presence of other concurrently online shoppers from the buddy list, allows for the shoppers to communicate and move to each other's present position within the shopping mall. When both shoppers are at the same virtual position within the shopping mall, they are presented with the same product information or virtual mall images and sounds, such that they may communicate with each other about a product or store in the mall.

In a further enhancement of the invention, the shoppers may find other shoppers by common interest terms, and may introduce shoppers to each other to build group conversations.

### DETAILED DESCRIPTION OF THE INVENTION

The invention is provided preferably as an application program executable by a web browser device, such as a personal computer, or a suitably equipped mobile device such as a personal digital assistant (PDA), web-enabled wireless telephone, handheld personal computer, or other Internet appliance.

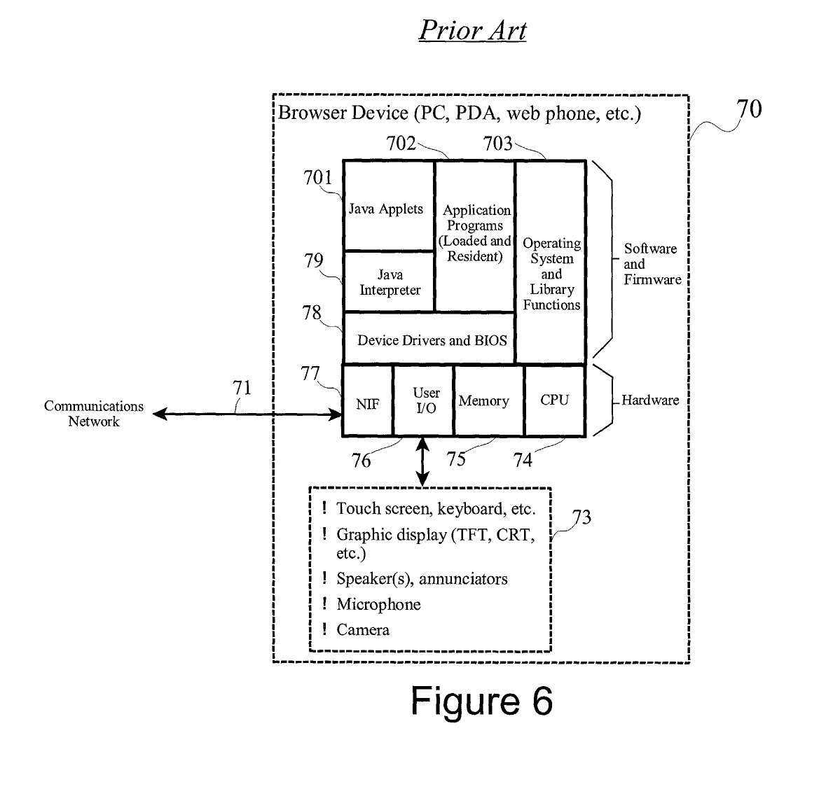

Turning to FIG. 6, the generalized arrangement of such web-enabled browsing devices (70) is shown. The browser device (70) includes a CPU or microprocessor (74), system memory (75) such as RAM and ROM, and a set of user interface devices (73) including a graphical display such as a color LCD panel. Other user interface devices commonly provided on browser devices include a touch-screen input, keyboard, pointing device, speakers, microphone and camera.

The browser device (70) is also provided with an operating system and set of library functions (703), such as Linux, Unix or Microsoft Windows [TM] on a personal computer, or such as Palm Computer's PalmOS [TM] on a handheld PDA. The library functions may include a communications protocol stack such as TCP/IP, electronic mail functions such as a Simple Mail Transfer Protocol (SMTP) suite, and user interface functions such as handwriting recognizors.

A suitable communications network interface (77), such as a dial-up modem, wireless modem, or Infra Red communications port (IRDa), to a communications network (71), such as the Internet, a telephone network or a wireless network, is also preferably provided in the browser device. Device drivers (78) allow abstraction between the library functions and the application programs (702).

Browser devices are typically provided with a suite of resident or pre-loaded applications such as phone books, “to do” list managers, calendars, email browsers, etc. Other application programs may be installed by downloading from a communications network server, or by installation from a memory device such as a FlashROM card, PCMCIA card, floppy disk or Compact Disk drive.

This general representation of browsing devices is representative of a wide variety of available products, from personal computers, to PDA's such as the Palm Pilot [TM], to web-enabled wireless telephones such as Motorola's StarTac[TM], to Internet appliances such as Cidco's MailStation[TM].

According to the preferred embodiment, the present invention is realized in combination with an IBM-compatible personal computer running the Linux operation system and a graphical web browser such as Arachne Labs Arachne WWW Browser, configured with a dial-up modem for access to the Internet, as well as a keyboard, pointing device (mouse, trackpoint, trackball, etc.), sound card, microphone and speakers. Alternative embodiments may include a personal computer running Microsoft's Windows [TM] operating system, with Netscape's Navigator [TM] web browser program, or any other suitable web browsing device.

While the computing platform of the preferred embodiment has been selected due to its open operating system, it will be recognized by those skilled in the art that realization of the invention on any other suitable platform may be made without departing from the spirit and scope of the invention.

Further according to the preferred embodiment, by combining the present invention with the technology of the related applications, an online shopping mall may provide the “shoppers” with a realistic shopping experience including presentation of visual images and audible sounds relevant and coordinated to a shopper's “position” within the cybermall. As a shopper “moves” through the cybermall, graphical images of mall hallways are presented in logical sequence showing store fronts and facades, with selectable areas in the images defining entry points to enter the stores. As stores are entered, specific images of store interiors are provided, allowing each store to control and generate an environment within their own store. During the entire experience, relevant audible sounds are provided to the shopper such as general mall hallway sounds while in the mall, and store-specific background sounds and music while in a selected store. It will, however, be recognized by those skilled in the art that the present invention may be used independently from the technologies of the related applications to enhance any online shopping service, including those currently found in the art.

The remainder of the disclosure given herein is made in terms of the method implemented in an application program, or portable applet, targeted for the browser device. According to the preferred embodiment, the method set forth is embodied in a Linux application program which cooperates with a web browser program. Several suitable C and C++ compilers are available for use in compiling the application program. Alternatively, the invention can be realized as a portable, downloadable executable program, such as a Java applet.

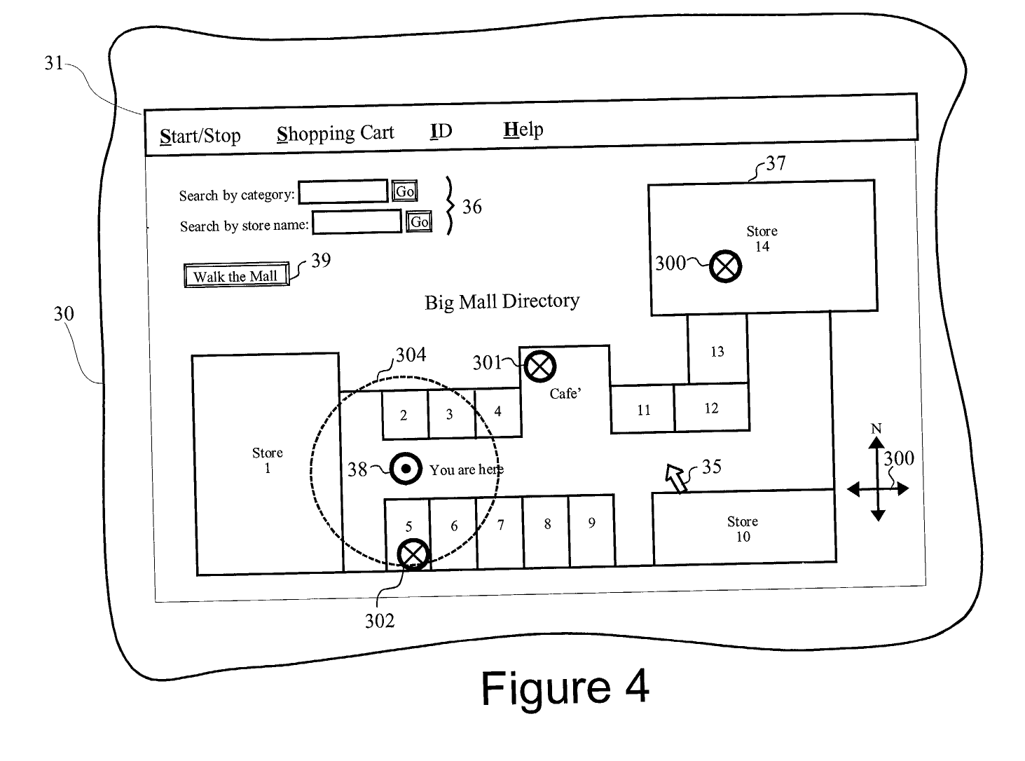

Turning to FIG. 4, the enhanced mall front page (31) provided by the invention is shown. According to the disclosure of the related patent applications, this graphic image is displayed on a portion (30) of the browser device's graphical display. In this view, the mall map (37) is enhanced to include a shopper position indicator (38), and preferably a geographic orientation icon (300).

Based upon a current coordinate or virtual position of the “shopper” within the mall, maintained by the application program, the shopper may see his or her position within the mall floorplan. Preferably, the shopper may “click and drag” the shopper position indicator (38) using the pointer (35) to move to another position within the mall, or go directly to another position within the mall floorplan by double clicking anywhere in the floorplan.

Further, the mall front page is enhanced to include a “walk the mall” button or icon (39), which invokes the multimedia experience of the invention. This could alternatively be invoked by the double clicking action previously described.

According to the present invention, the mall map (37) is enhanced to included one or more buddy position indicators (300, 301, 302) such that the shopper may see where any concurrently shopping buddies are located. Further, the shopper may initiate communications in a chat-like format (text, audio, video, or combination of these) by selecting one or more of these buddies, such as by clicking on one or more of the buddy position indicators. Alternatively, for embodiments without the graphical mall map presentation, the shopper may be presented with a list of concurrently online buddies, with a list of their “locations”, from which he may select to initiate communications with one or more online shopping buddies.

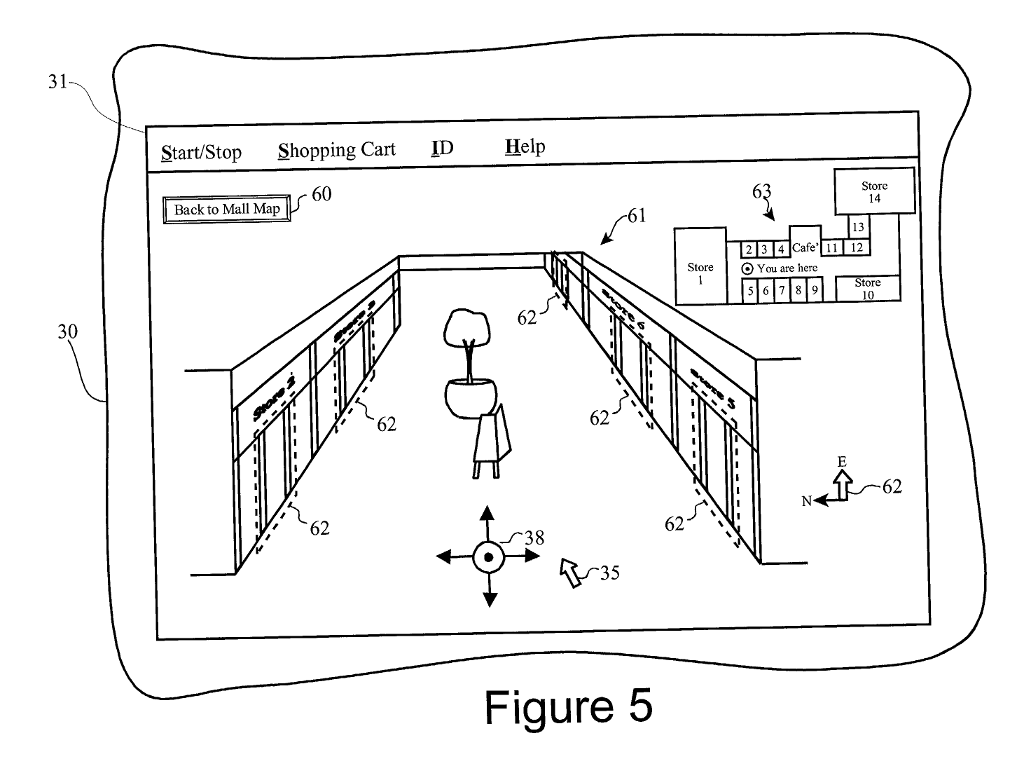

FIG. 5 shows an example presentation of the visual image from a given position within a mall floor plan, including store facades, and the position indicator (38), as set forth in the related patent applications. The position indicator (38) may be provided with arrows or pointers showing possible directions of movement. A view indicator (62) also may be provided to allow the shopper greater understanding of which direction he or she is “facing” in the cybermall, as well as a miniaturized mall floor plan (63) for more efficient navigation of the cybermall. A button or icon (60) to return to the mall front page is also preferably provided.

From this view, the user or shopper may click and drag the position indicator (38) using the pointer (35), or a combination of keys, to move through the mall. As the shopper's position is changed, the presented image is updated accordingly.

The image may be a photograph, such as images taken from within an actual mall, in the form of well-known graphic web objects (GIF, JPEG, etc.), or a simulation of an real view of the mall using vector and/or bitmap graphics similar to those used in gaming technologies.

Further according to the related patent applications, the images are provided with “hot spots” (62) or regions within the images that, when selected, activate a hyperlink to other images or other web pages. Such hot spots may be place over and around store doors, windows, and hallway turns. For example, to enter a particular store, the user could click on the door for the store. Or, to take a direct view into the display window of a store, the user could click on the image of the window. Methods to provide hot spots in graphic images with hyperlinks are well known in HTML and other common web object types.

According to the preferred embodiment of the present invention, the shopper is enabled to “jump” to the location or view of another concurrently online shopping buddy. So, for example, a shopper may select a particular buddy indicator on the map, such as by double clicking the indicator with the pointer, which will cause his current position to be replaced with the current virtual position coordinates of the selected shopping buddy. This, then, results in his being presented with the same visual images and/or sounds that the buddy is currently viewing. Communications between the buddy and the shopper may then ensue, probably regarding the product or store being currently view.

In an example use of these two capabilities (communications and jumping), a shopper, who is currently viewing products from an online sporting goods store, may notice that a buddy is currently shopping at an online music store. The shopper, having and interesting new sporting product to discuss with the buddy, then selects that buddy and chats with the buddy about the sporting product he is currently viewing. The buddy is interested, so the buddy selects to “jump” to the shopper's position, such that the buddy is presented with the same view as the shopper. Then, the conversation may continue, probably about the product itself. This may lead to both of the shoppers to making a purchase.

In an alternate embodiment without the graphical mall presentation as set forth in the related applications, and potentially in combination with other online shopping services, the “jump” function would simply take the “jumper” to the same hyperlink or web address as the buddy or other shopper.

In a further enhancement of the invention, the buddy list of a shopper may be automatically updated as a buddy “introduces” the shopper to a third party who is not currently listed on the shopper's buddy list. For example, shopper A has a buddy list which includes shopper B. Shopper B has a buddy list which includes shopper A and shopper C. Shopper B, then, may introduce shoppers A and C, and the system will automatically add shopper C to shopper A's buddy list, and it will add shopper A to shopper C's buddy list. Then, in future shopping sessions, shoppers A, B, and/or C will all be notified when any other shopper on their list is concurrently shopping in the online shopping mall. This feature, used in conjunction with the graphical mall presentation technology or in conjunction with conventional online shopping services, as another social aspect to the online shopping experience—that of meeting new friends and widening a circle of friends, which further enhances the likelihood that products may be purchased through the online shopping services (increased visitations, buddy referrals, etc.).

According to another enhancement of the present invention, chat groups may be established between multiple shoppers, and of course jumping and introductions may be used in combination with chat groups. For example, two buddies may find each other in a shopping mall, and may be engaged in a discussion and may have jumped to common location within the online shopping mall. One of the buddies may notice that another buddy has entered the online shopping mall, and may build a three-way chat group between the first buddy and the second buddy. If the other two buddies are not currently on each other's buddy list, they may be “introduced” such that they are each added to the other's buddy list.

In yet another enhancement of the present invention, a proximity detector and notifier may be provided. As shown in FIG. 4, a shopper may configure a certain proximity zone (304), such as a virtual distance radius or a parameter such as “within the same virtual store”. The system, then, continually compares the virtual position of the shopper with the positions of other shoppers, and notifies the shopper of the “presence” of another shopper which meets given criteria. On set of criteria may be that the detected shopper must already be on the shopper's buddy list, allowing the shopper to “bump into” friends on his or her buddy list as he or she moves through the mall.

Other criteria, though, may be based upon common or mutual interest terms in the shoppers' profiles, which allows the pseudo-random meeting of new potential buddies. For example, if two shoppers have profiles containing jazz music as an interest term, and they are near each other in the online shopping mall (perhaps in the same store or within the same virtual aisle), they may be notified of each other's presence and allowed to communicate or chat with each other.

This simulates the social experience of meeting someone for the first time in a retail establishment based upon obvious mutual interests. For example, two shoppers may be looking at books from the same author in a book store, both located on the same aisle. One shopper, then, may ask the other shopper if he or she has read more books from this author, and a discussion may ensue, as well as the possibility for forming a new friendship or relationship. Further, if the second shopper gives a positive or favorable opinion about the product, the first shopper may be inclined to make the purchase. Additionally, the potential for meeting new friends may provide incentive to “visit” the online mall more often and for longer periods of time, also increasing the chances of purchases being made.

In yet another enhanced embodiment, the proprietor of an online mall or stores within the mall may be provided with records of the discussions held within the mall or stores. This types of “eaves dropping” may be instrumental in gathering marketing information about the products or services being offered. For example, a chat held in an outdoors products store between two shoppers may reveal the shopper's satisfaction with a particular product (e.g. the shopper gives a positive opinion), dissatisfaction, or preference for an alternative or competitive product. This type of honest opinion is often difficult to gather through surveys and studies, but in a more casual atmosphere, is readily available. Implementation of this type of chat recording may require consent or notification to the shoppers, depending on a company's corporate policies and/or relevant laws and regulations regarding such activities. However, for the purposes of the present invention, it is a technical feature available to online retailers.

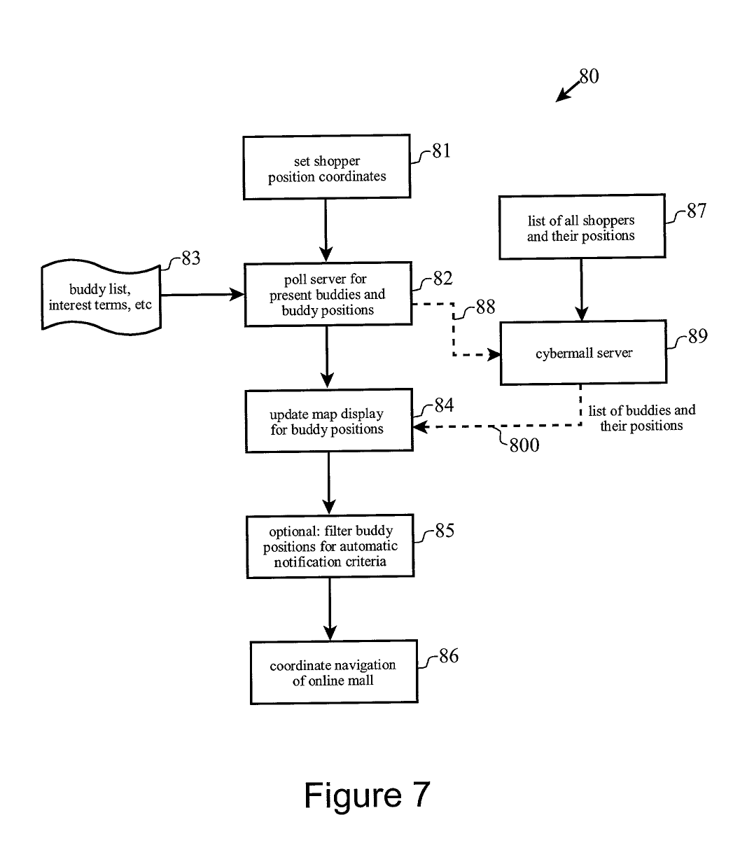

Turning to FIG. 7, the logical process (80) performed by the “buddy finder” application program for providing the shopper with the enhanced graphical map of the online mall including the buddy indicators. Each time the shopper moves his or her own position within the virtual mall, such as by clicking and dragging the shopper position indicator, the shopper position coordinates are updated (81) to reflect the new position. According to the preferred embodiment (coupled with the graphical mall presentation of the related patent application) this would automatically cause the shopper's presentation and view to be updated.

Then, the buddy finder program accesses the shopper's buddy list (83), and polls (82) the shopping mall server for all currently online shopping buddies and their current positions. The shopping mall server (89) retrieves all of the buddy positions from a master list of all online shoppers (87) and returns to the application program a list (800) of all online buddies and their positions.

The polling for online buddies may also be done periodically so that it is updated even when the shopper is not moving. The shopper and buddy position coordinates can be as precise as X-Y coordinates from a grid within the virtual mall space, or somewhat coarse such as store names or major mall sections (Bookstore, Café, Main Corridor, etc.).

Then, the shopper's map is updated (84) to reflect the current positions of each online buddy using buddy indicators, as previously discussed. In alternate embodiments, the buddy finder application program may actually be an applet running in the browser device, or it may be a servlet or other program instance running on a server. In the later case, the browser device may simply report the new shopper position to the server, and the server may have a local copy of the buddy list so that it can filter the master list of online shoppers. Also, the graphic image of the map including the buddy position indicators can be created by the application program running on the browser device, or can be generated by the server and downloaded to the browser device.

Next, an optional comparison (85) of the shopper's current position is made to the online buddy position(s), preferably by the application program on the browser device but alternately by the server. A comparison of interest terms (for meeting strangers) may also be made optionally. If any online buddies meet the shopper's criteria, such as having a position within a certain radius, having matching interest terms, or being within the same virtual store, the shopper may be so notified that a buddy has be “found” or “bumped into”.

Finally, normal navigation (as disclosed in the related patent application) is resumed (86).

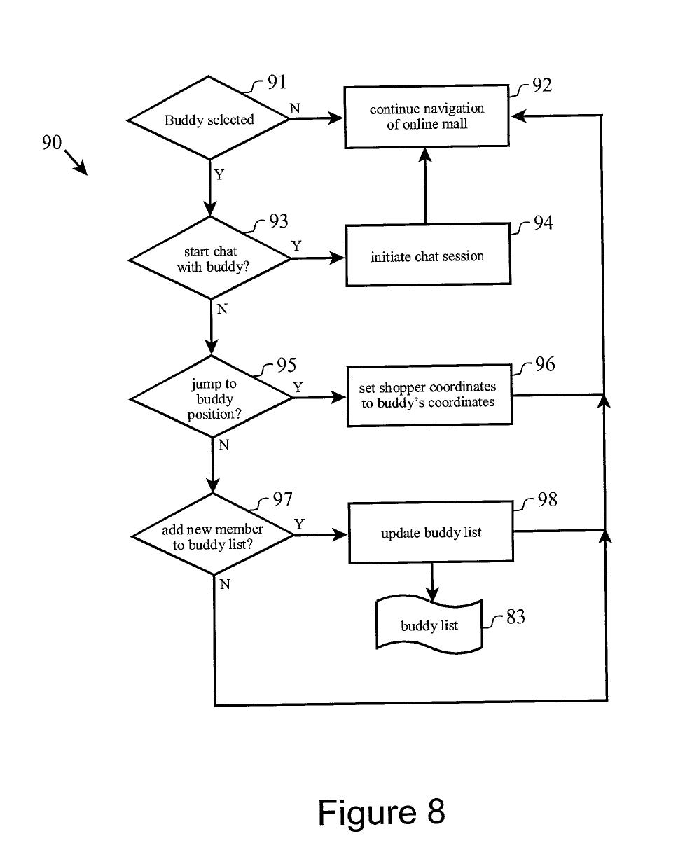

When the shopper selects a buddy, such as by clicking on a buddy position indicator or selecting an entry in a list of online buddies, the logical process of the invention as shown in FIG. 8 is followed. When the buddy is selected (91), if the selection was the type of action to indicate the shopper desires (93) to communicate with the buddy, such as a “single click”, then a chat session is initiated (94) with the selected buddy, and navigation of the mall may continue (92).

If the selection action is of a type which indicates the shopper desires (95) to jump to a selected buddy's position, such as by double clicking a buddy position indicator, the shopper's current position coordinates are set to the same value as the selected buddy's position coordinates, and normal navigation of the online mall is resumed (92). According to the method of the related patent application, this changing of positions to equal that of the selected buddy will cause the shopper's graphical multimedia presentation of the mall interior or products to be the same as those being viewed by the selected buddy.

If the selection action is of a type which indicates the shopper wants (97) to add a new buddy to his or her own buddy list, such as by right-clicking a current buddy to select a buddy's buddy, the shopper's buddy list (83) is updated (98), and navigation of the mall is resumed (92). This is a useful for the “introduction” feature of the invention, whereby one common buddy can be the link through which two or more other buddies and add each other to their own buddy lists.

The methods as shown in FIGS. 7 and 8 are appropriately organized for implementation and realization using object oriented programming techniques. However, use of non-OOP programming methodologies may be made without departing from the scope of the invention.

While specific details of the preferred embodiment and alternate embodiments have been disclosed herein, it will be recognized by those skilled in the art that many substitutions, variations and alternate embodiments may be adopted without departing from the spirit and scope of the invention. For example, other programming techniques, device hardware platforms, and data object types may be adopted as suitable and as they become available. The scope of this invention should be limited only by the language of the following claims.

What is claimed is:

1. A method for providing enhanced online shopping experiences to online shoppers for automatic association of two or more online shoppers, said method comprising the steps of:
searching a list of concurrently online shoppers according to a set of search criteria;
notifying a first online shopper that at least one concurrently online shopper meets said search criteria; and
automatically associating said first online shopper with said one or more concurrently online shoppers.

2. The method as set forth in claim 1 wherein said step of notifying a first online shopper comprises providing a buddy position indicator on a graphical map of an online shopping mall.

3. The method as set forth in claim 1 wherein said step of searching a list of concurrently online shoppers according to a set of search criteria comprises searching by an online shopper name criteria.

4. The method as set forth in claim 1 wherein said step of searching a list of concurrently online shoppers according to a set of search criteria comprises searching by an online shopper position criteria.

5. The method as set forth in claim 1 wherein said step of searching a list of concurrently online shoppers according to a set of search criteria comprises searching by an online shopper interest term criteria.

6. The method as set forth in claim 1 wherein said step of searching a list of concurrently online shoppers according to a set of search criteria comprises searching by an online shopper position proximity criteria.

7. The method as set forth in claim 1 wherein said step of automatically associating said first online shopper with said one or more concurrently online shoppers comprises setting position coordinates for both shoppers to equivalent values.

8. The method as set forth in claim 1 wherein said step of automatically associating said first online shopper with said one or more concurrently online shoppers comprises establishing a communications session between said online shoppers.

9. The method as set forth in claim 8 wherein said step of establishing a communications session between said online shoppers further comprises making a record of said communications session.

10. A computer readable medium encoded with software for providing enhanced online shopping experiences to online shoppers for automatic association of two or more online shoppers, said software when executed by an online shopping computer system causing computer system to perform the following actions:
search a list of concurrently online shoppers according to a set of search criteria;
notify a first online shopper that at least one concurrently online shopper meets said search criteria; and
automatically associate said first online shopper with said one or more concurrently online shoppers.

11. The computer readable medium as set forth in claim 10 wherein said software for notifying a first online shopper comprises software for providing a buddy position indicator on a graphical map of an online shopping mall.

12. The computer readable medium as set forth in claim 10 wherein said software for searching a list of concurrently online shoppers according to a set of search criteria comprises software for searching by an online shopper name criteria.

13. The computer readable medium as set forth in claim 10 wherein said software for searching a list of concurrently online shoppers according to a set of search criteria comprises software for searching by an online shopper position criteria.

14. The computer readable medium as set forth in claim 10 wherein said software for searching a list of concurrently online shoppers according to a set of search criteria comprises software for searching by an online shopper interest term criteria.

15. The computer readable medium as set forth in claim 10 wherein said software for searching a list of concurrently online shoppers according to a set of search criteria comprises software for searching by an online shopper position proximity criteria.

16. The computer readable medium as set forth in claim 10 wherein said software for automatically associating said first online shopper with said one or more concurrently online shoppers comprises software for setting position coordinates for both shoppers to equivalent values.

17. The computer readable medium as set forth in claim 10 wherein said software for automatically associating said first online shopper with said one or more concurrently online shoppers comprises software for establishing a communications session between said online shoppers.

18. The computer readable medium as set forth in claim 17 wherein said software for establishing a communications session between said online shoppers further comprises software for making a record of said communications session.

19. A system for providing enhanced online shopping experiences to online shoppers for automatic association of two or more online shoppers, said system comprising:
a master list of concurrently online shoppers
a buddy list searching facility adapted to search said master list of concurrently online shoppers according to a set of search criteria;
an online shopper notifier for notifying a first online shopper that at least one concurrently online shopper meets said search criteria; and
a shopper associator adapted to automatically associating said first online shopper with said one or more concurrently online shoppers.

20. The system as set forth in claim 19 wherein said notifier comprises a buddy position indicator on a graphical map of an online shopping mall.

21. The system as set forth in claim 19 wherein said searching facility is adapted to search by an online shopper name criteria.

22. The system as set forth in claim 19 wherein said searching facility is adapted to search by an online shopper position criteria.

23. The system as set forth in claim 19 wherein said search facility is adapted to search by an online shopper interest term criteria.

24. The system as set forth in claim 19 wherein said search facility is adapted to search by an online shopper position proximity criteria.

25. The system as set forth in claim 19 wherein said associator is adapted to set position coordinates for two or more shoppers to equivalent values.

26. The system as set forth in claim 19 wherein said associator is adapted to establish a communications session between two or more online shoppers.

27. The system as set forth in claim 26 wherein said associator for establishing a communications session between online shoppers further comprises a communications recorder making a record of said communications session.
